(19) United States
(12) Patent Application Publication
(10) Pub. No.: US 2025/0291315 A1
(43) Pub. Date: Sep. 18, 2025

(54) DEVICE FOR DISPLAYING A UNIT OF TIME

(71) Applicant: MIQONA GMBH, Konstanz (DE)

(72) Inventors: Aric Marc MERZ, Reichenau (DE); Alexander BOEHM, Konstanz (DE); Ruven DREISCHKE, Neustadt an der Weinstrasse (DE)

(73) Assignee: MIQONA GMBH, Konstanz (DE)

(21) Appl. No.: 18/862,448

(22) PCT Filed: May 3, 2023
(86) PCT No.: PCT/IB2023/054612

§ 371 Date: Nov. 22, 2024

(30) Foreign Application Priority Data
May 3, 2022 (DE) 10 2022 110 815.5

(51) Int. Cl. G04B 19/20; G04B 19/04

(52) U.S. Cl. CPC G04B 19/202; G04B 19/046; G04B 19/048

(57) ABSTRACT

A time-indicating method includes at least of a time-indicating device for the hours and an additional time-indicating device for the minutes, wherein the time-indicating devices are indicating elements with a bearing point, and the bearing point of each time-indicating device is arranged on a common axis. An additional display element is rotatably arranged on the common virtual axis, and each display element has a slot extending from the outer circumference to the bearing point such that the slots rotate one below the other and independently of one another, wherein one, two, or three display elements are moved in an alternating manner via a setting device.

The invention relates to a display of a device and to a method for indicating a unit of time, wherein the display of the unit of time consists of portion segments, which change, of circular disks that rotate in the same direction within one another, in a direction of rotation about a common axis, which segments together form a full circle, and the circular disks differ from one another optically, as well as to a clock/watch having this display.

### Definition

To describe the technical function of the display elements that interact with one another here, the term helical is used. This should be understood to mean the following: Helical means that something is moving in a spiral shape. This can happen in a curve that rotates to the right or to the left. It is a very frequent pattern in natural shapes such as snail shells or in the DNA molecule. Examples of a helix are a screw line, a cylindrical spiral or a coil. A helix is a curve that winds around the mantle of a cylinder at a constant incline. In the present case, the mantle is configured to be imaginary and the distance from this mantle is preferably always constant, measured from the circumference surface to the mantle.

### STATE OF THE ART

Time-indicating elements, for example a clock/watch face, have an hour hand, a minute hand, as well as frequently also a second hand. In general, the current time of day can be derived from such time-indicating devices with an accuracy to the second. The drive mechanism can be configured either mechanically and/or electronically. A typical clock/watch face is divided into at least four, preferably twelve uniform segments, which are distributed radially about a central axis of rotation of the clock/watch. The beginning and end of a segment is frequently marked by a clock/watch face marking, which can be configured, for example, in the form of a line, a dot or in some other suitable form, and is frequently applied to the clock/watch face, preferably imprinted. Frequently, numbers are also assigned to the clock/watch face markings, indicating the whole hour, in each instance. The twelve markings for the individual hours are frequently furthermore divided into five segments of equal size, and thereby the clock/watch face has 60 segments arranged uniformly, by way of which the minutes and seconds can be read precisely. The hands are arranged above the clock/watch face in such a manner, and rotate about a common axis of rotation in such a manner that the clock/watch face serves to indicate the current hour by means of the hour hand, the current minute by means of the minute hand, and the current second by means of the second hand.

In this regard, the hour hand is arranged above the clock/watch face in a plane above the plane of the static clock/watch face, and rotates about a common axis of rotation, within twelve hours, by 360° clockwise (around to the right, seen in a top view). The minute hand is arranged in a subsequent plane and rotates about the common axis of rotation by 360° within one hour. The minute hand is followed, in a further plane, by the second hand, which rotates about the common axis of rotation by 360° within one minute.

Furthermore, clocks/watches are known that deviate from these very traditional representations. These types of clocks/watches provide not only an indication of the time but also esthetic values. For this purpose, times or also time ranges are displayed in words or colors, so that a completely different representation is provided as compared with a traditional clock/watch, but nevertheless the time of day can be determined, at least approximately.

A number of inventions, such as, for example, the publication CH 534379, US 2006104160 as well as U.S. Pat. No. 4,939,708, GB 2376089, U.S. Pat. No. 6,683,821, DE 3731872 have set themselves the task of changing the appearance of the “clock/watch with hands” as described above, in that in place of one or more display elements, a helical, optically contrasting pair of disks having a common center point and provided with a radial slot is used, in each instance. Starting from the 12 o'clock position as a scale reference point, in each instance, the disk to the rear, at first, is displaced clockwise, by means of a rotational movement, as a function of the time, completely in front of the disk that covers it at first, through its radial slot, wherein the circle segment sector that becomes visible, formed by the exit location at the 12 o'clock position and the visible radial slot of the disk that is moving to the front, shows the progression of the variable value being indicated, in each instance, cumulatively and “at a glance” as compared with the known clock/watch with hands, and thereby with a greater intuitive assessment of the time being indicated. It is proposed, in the case of 12-hour clocks/watches, to distinguish between daytime and nighttime hours by means of alternating superimposition of the hour disks in a 12-hour rhythm, for example in that the brighter disk indicates the 12 “daytime hours” and the darker one indicates the 12 “nighttime hours” of a 24-hour day, or to indicate the 12-hour rhythm in a fixed manner, in each instance, at the 6 o'clock or 8 o'clock position, in order to thereby reflect the progression of light of a 24-hour day fairly true to reality.

From CH 707 531 A2, a time of day indication method as well as a watch are known, in which hour symbols are used to display the time. The method relates to a time of day indication method with which hour symbols are used to indicate the time of day, as well as to a watch. The 24 hours are indicated, using the time of day indication method, in a changing and continuous manner, at a fixed time, using specific hour symbols. The watch consists of a small lower cover plate, a circuit board, a small non-transparent plate, a small transparent plate, a watchhand center, a small glass plate, and a small upper cover plate. The small lower cover plate is formed with a chamber in which the circuit board is installed. Twelve LED lights are arranged in ring shape distributed on a surface of the circuit board. The small non-transparent plate, the small transparent plate, the watchhand center, and the small glass plate are mounted on the circuit board in this sequence. The small upper cover plate and the small lower cover plate are then combined with one another so as to assemble the watch. Twelve hour symbols are formed on the small non-transparent plate, as numbers on the watch face of the watch, in ring shape. The LED lights emit the light onto the surface of the small transparent plate, so as to indicate the hour symbols by means of illumination. With this structure, the watch can be created using the time of day display method, using a dynamic display of the time of day.

From DE 20 2014 007 551 U1, a designer watch having a half-round watch face is known. It is characterized in that the hour face is half-round with two opposite hour indicators attached to it, which advance at a speed of one revolution per 24 hours, with this indicator being seen within the first 12 hours while the other indicator hides behind a partition wall, and within the subsequent twelve hours, it is the opposite, so that the whole cycle repeats in a 24-hour rhythm, with the minute indicator being visible at all times and advancing at a speed of one revolution per hour.

From DE 10 2015 007 866 A1, a time-indicating device is known, which comprises at least a static display element arranged in a first plane, an indicator element arranged to rotate in a second plane, and an indicator element arranged to rotate in a third plane, wherein the first to third planes are arranged parallel to one another and following one another, and wherein the indicator elements are alternatively configured as hands and as watch faces, and wherein the rotating indicator element and rotate relative to one another, about a common point of rotation or a common axis of rotation, in such a manner that the indicator element performs a dual function.

From EP 0 209 335 A2, a clock/watch is known, which has a static clock/watch face having twelve clock/watch face markings. Furthermore, a dynamic clock/watch face having 60 clock/watch face markings is provided, which rotates about a common axis of rotation with an hour hand and a minute hand. The hour hand is connected to the dynamic clock/watch face in a mechanically firm manner, and rotates by 360° within twelve hours. The minute hand rotates about the same common axis of rotation by 390° in an hour. Furthermore, a second hand is mentioned, which rotates about the common axis of rotation by 360.5° in a minute. Therefore the hour hand rotates synchronous to the static clock/watch face, the minute hand rotates synchronous to the hour hand and to the dynamic clock/watch face firmly connected to it. The second hand also rotates synchronous to the hour hand and to the clock/watch face firmly connected to it.

From US 2006-0104160 A1, a visual indicating device is known, which comprises two disks, wherein each disk has a radial slot, so as to thereby form a surface, the plane of which runs in a helical manner, wherein the disks are arranged one above the other and into one another, and lie in helical planes that are parallel to one another. In this regard, each disk can rotate independently about a common axis, using drive means that are suitable for optionally rotating the one or the other of the disks, and thereby the disks, when viewed from the direction of the axis, display overlapping, visually contrasting segments, which have a range or a position that is representative for the relative rotational positions of the disks and represents a value of a parameter to be indicated by the device.

The mechanical analog display of clocks/watches according to DE 196 02 574 A1 shows the time with two changing parts of sectors that complement one another to form a full circle or a circular ring. The sectors are the visible part of two helical surfaces that lie within one another and are oriented in the same direction, and alternately rotate coaxially by 360 degrees. The non-visible parts of the helical surfaces are connected, at the lower end, with a drive shaft, in each instance, wherein one helical surface has one winding more than the other. As the result of the different angular dimensions of the helical surfaces, an arrangement of the drive shafts that is similar to conventional clocks/watches with hands is guaranteed, along with easy technical implementation. A combination of two helical surface pairs for separately indicating hours and minutes is also presented.

In DE 2015 446 A, a device for indicating an angular position, which corresponds to a time of day, is represented in that it consists of at least one pair of circular ring disks, the two circular disks of which pair are slit and helically wound into one another, extend over at least 360° and are mounted, relative to one another, so as to rotate on a locally fixed housing part, as well as guides for axial guidance, and that an adjusting organ engages on one of the disks, so as to entrain it, while at the same time, the other disk is held in place by means of a stop.

### Disadvantages of the State of the Art

The representations with regard to time previously known from the state of the art are restricted, as a rule, to a minute display, and are coupled in such a manner that the disks represent a replacement for the hands previously known from the state of the art. Driving the individual disks leads to the result that a very complex mechanism must be provided. This mechanism has a very extensive construction, so that a simple and flat embodiment, as it is desired for a wall clock, for example, cannot be implemented.

Furthermore, the embodiments are very complex, and this also makes their production very expensive.

### Task of the Invention

It is the task of the invention to make available a time-indicating method by means of which both the current time of day and the time remaining until the next whole hour are indicated in a simple manner, wherein at the same time, a flat, compact method of construction should be taken into consideration.

### Solution for the Task

The solution for the task is provided by means of the characteristics of claim 1.

### Advantages of the Invention

The observer and the user can recognize the time of day, as well as the ratio of the elapsed time and the future time for one (1) hour segment at a glance. The device and the method are characterized by the interplay of three display elements in the configuration of circular disks that interact with one another. These can be read very easily the actual time of day and, at the same time, also the time remaining until the next whole hour, in a very interesting and impressive manner. In this regard, the device departs from the usual representation that the 60 minutes of an hour are always represented by the start at «12 o'clock» and a degree of rotation of 360 degrees, 6 degrees per minute. It is characteristic for the invention that the hour, starting from the full time of day (for example 8 a.m. or 3 p.m.) always proceeds from this position of the segment of the circular disk that characterizes the hour.

Three circular disks that can be optically differentiated from one another are provided, each having a bearing point: Furthermore, these circular disks each have a radially marked slot that extends from the circumference side all the way to the bearing point. A first and a second circular disk are laid on top of one another in such a manner that the radial slot, in each instance, is congruent to the other slot. The third circular disk is inserted into the slot of the first and second circular disk, perpendicular to them, and then arranged to lie flat. As a result, the third circular disk covers the first and/or second circular disk on the two planar sides. As a result, the circular disks are interlaced over their surfaces and form a helical structure having a common axis, but nevertheless each circular disk can rotate on its own, freely about its own bearing point. By means of rotating the circular disks differently, the result is brought about that the function of the circular disk in question changes hourly.

At first, the first circular disk is assigned to the display of the minutes and the second circular disk is assigned to the display of the hour. The third circular disk represents the remaining time until the next whole hour, and rests.

After a 360 degree revolution of the first circular disk, the latter changes to a display of the remaining time, the third circular disk becomes the display of the hour and moves 30 degrees in the clockwise direction, and the second circular disk now becomes the display of the minutes, starting from the position in which the third circular disk assumed the position for this hour.

After a further 360 degree revolution of the second circular disk, the latter changes to the display of the remaining time, the first circular disk becomes the display of the hour, and the third circular disk becomes the display of the minutes.

After every full revolution, the circular disk that displays the remaining time rotates further by 30 degrees and forms a narrow partial segment between the slots. It indicates the position of the hour, in each instance. This partial segment assumes the position of the whole hours, in each instance, such as, for example, 2 a.m., 2 p.m., 8 a.m., 8 p.m., etc., in the case of a clock/watch that shows the actual time.

Starting from this position, the circular disk that is facing the viewer, in each instance, then begins the 360 degree run and indicates the minutes. In this regard, this circular disk forms a partial segment that represents the elapsed time. At the same time, the display of the time remaining to the whole hour is formed between this circular disk and the circular disk that is resting.

For this reason, the time of day can best be read when the corresponding circular disks are structured differently and differ from one another at least optically.

It is advantageous if, as a drive unit for the respective circular disks, such solutions are proposed in which a circular disk, in each instance, is assigned to a drive disk, in such a manner that the drive disk provides for a connection to the circular disk and rotates this circular disk about the axis or about the bearing point of the circular disk. Thereby a drive disk is assigned to each circular disk.

In total, three drive disks are provided. The drive disk itself is a flat structure that is configured with rotation symmetry and has a bearing point. Furthermore, a common axis is provided, wherein the corresponding bearing point of the circular disk lies on the axis.

A first embodiment is structured as follows:

The third drive disk has a circumferential surface at a distance from the bearing point, which surface has one or more holding points at its free end, in each instance. The second drive disk is also structured with rotation symmetry and has a circumferential surface at a distance from its bearing point, but the distance of this surface is less than the distance of the bearing point from the surface of the third drive disk. A part of the surface of the second drive disk slides on the third drive disk. The first drive disk has a circumferential surface at a distance from the bearing point, which surface also has one or more holding points. This surface is has an even smaller distance from the bearing point, in contrast to the distance of the surface of the second drive disk. This first drive disk slides on a part of the surface of the second drive disk.

The free ends of the respective drive disks lie in a common plane, so that these can form the holding points for the respective circular disks.

In order that these drive disks can also be driven by means of one or more actuating motors, drive sleeves are provided, which are arranged in one another, in each instance, and connected to the drive disks. These drive sleeves are arranged in the center, so as to rotate on or about the axis, and in such a manner that in the region of the free end of the drive sleeve, in each instance, namely on the side facing away from the drive disk, drive means can be affixed directly or indirectly. These drive means, such as, for example, a drive wheel or a gear wheel or also a belt, can be coupled with an actuating motor, in each instance. Each drive sleeve has a separate actuating motor.

The respective actuating motors are driven by way of a control unit. The control unit is preferably regulated by way of software, in such a manner that first, calibration and thereby positioning of the circular disks takes place, and then setting of the time of day takes place as a function of the time signal. Alternatively, the time can simply run, so that the observer recognizes how much time has elapsed or still remains (timer function).

A second embodiment is structured as follows:

The third drive disk has a circumferential surface at a distance from the bearing point, which surface has one or more holding points on its free end, in each instance. The second drive disk is also structured with rotation symmetry and has a circumferential surface at a distance from its bearing point, but the distance of this surface is less than the distance of the bearing point from the surface of the third drive disk. The second drive disk is arranged in the same plane as the first drive disk. Furthermore, the first drive disk offers a bearing possibility for the second drive disk on its inner side. This bearing possibility can be, for example, a tongue/groove connection, wherein the tongue can slide in the groove. Since the inner side of the second drive disk is also mounted in the outer side of the first drive disk, a bearing possibility is also provided so that sliding is possible, so the second drive disk can slide in the first drive disk and relative to the third drive disk. The first drive disk has a circumferential surface at a distance from the bearing, which surface has one or more holding points. This surface is has an even lesser distance from the bearing point, in contrast to the distance of the surface of the second drive disk. All three drive disks can rotate freely about their bearing point and thereby about the axis.

Preferably, the three drive disks can be easily produced by means of additive production (3D printing). As a result, it is advantageous that assembly and further components that must be mounted are avoided. The function of the drive disks is guaranteed immediately after their production.

In order to make it possible to drive the circular disks by means of the drive disks, and so that these also run within one another in a helical manner and assume different positions in a top view, it is provided that the circular disks are fastened in place in at least one holding point of the corresponding drive disk. Possible means of fastening that can be provided are, for example, an adhesive connection or also a releasable connection, for example a hook-and-loop connection or a magnetic connection.

For coupling of the corresponding circular disk to the drive disk, a connection element is provided, in each instance, which is arranged on the one side of the slot of the corresponding circular disk. It is advantageous if these are connected to the circular disk in one piece. The connection should be selected in such a manner that the circular disk can be rotated about the axis by means of being “pushed” by way of the connection element.

The connection elements are are arranged at a radial distance from one another in a top view of the circular disks. The particularly advantageous embodiment consists in that the connection element of the circular disk, in each instance, is articulated onto the slot from the one side of the slot, extends beyond the slot counter to the direction of rotation, and is attached at the holding point of the corresponding drive disk with the free end of the connection element.

Since the circular disks represent a circle, the connection element is adapted to the shape of the circular disk. The connection element, in a top view, has has a partial segment of a circle, and has the radius that corresponds to the radius of the corresponding holding point 32, 33, 34 relative to the axis 5.

The drive disks, in each instance, are driven by actuating motors, in each instance.

In order to guarantee a very compact and simple method of construction, it is proposed to use what are called torque motors. These have different diameters. They are arranged on the underside, the side that faces away from the circular disks. The corresponding torque motors are preferably set into one another, in such a manner that the outer largest actuating motor drives the first outermost drive disk. The actuating motor is also limited to just the mass of the corresponding drive disk, in such a manner that the further torque motor fits into the first torque motor and drives the second drive disk. The same holds true for the third torque motor, which drives the third drive disk.

Further advantageous embodiments are evident from the following description, the drawings, as well as the claims.

### DRAWINGS

The figures show:

FIG. 1 a spatial view of an arrangement of three circular disks for indicating a time;

FIG. 2 a schematic view of the three circular disks in an individual representation;

FIG. 3 [A-B] a schematic representation of bringing together the respective circular disks in multiple steps;

FIG. 4 [A-G] a representation of the different positions of the circular disks, which engage into one another in the manner of a helix, for representing a time of day, in a top view;

FIG. 5 [A-H] a representation of the different positions of the circular disks, which engage into one another in the manner of a helix, for representing a time of day, in contrast to FIG. 4 in a spatial side view;

FIG. 6 a section through the drive disks for driving circular disks [not shown in the drawing], according to a first exemplary embodiment;

FIG. 7 a top view of the first exemplary embodiment of the display of a device for representing a unit of time, together with the drive disks and the circular disks, wherein the circular disks are folded away for better visibility of the function;

FIG. 8 a top view of the drive disks for driving circular disks [not shown in the drawing], according to a second exemplary embodiment;

FIG. 9 a section through the drive disks according to FIG. 8, along a section line IX-IX;

FIG. 10 a top view of the first exemplary embodiment of the display of a device for representing a unit of time, together with the drive disks and the circular disks, wherein the circular disks are folded away for better visibility of the function.

### DESCRIPTION OF AN EXEMPLARY EMBODIMENT

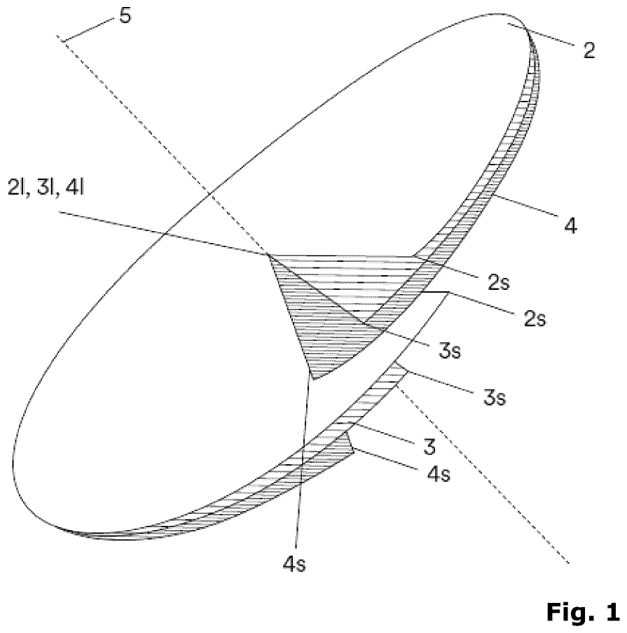

In FIG. 1, a spatial view of the principle of the time-indicating method is shown schematically. In order to indicate a time of day, three flat circular disks 2, 3, 4 are provided, which are coupled with one another. These flat circular disks are driven by at least one drive element—not shown in any detail in FIG. 1. The flat circular disks 2, 3, 4 each have a bearing point 2l, 3l, 4l and are arranged, relative to one another, in such a manner that they are mounted on a common imaginary axis 5, so as to rotate about this axis 5, at this bearing point 2l, 3l, 4l, and each one can rotate about the axis 5 independently of the other circular disk. Furthermore, each of the flat circular disks 2, 3, 4 has a slot 2s, 3s, 4s that extends from the outer circumference of the circular disk all the way to the bearing point 2l, 3l, 4l. The circular disks 2, 3, 4 are configured to be flexible in the region of the slot 2s, 3s, 4s, in such a manner that the circular disks 2, 3, 4 can be interlaced with one another, so that these together form a helical structure, as shown in an overall view in FIG. 1.

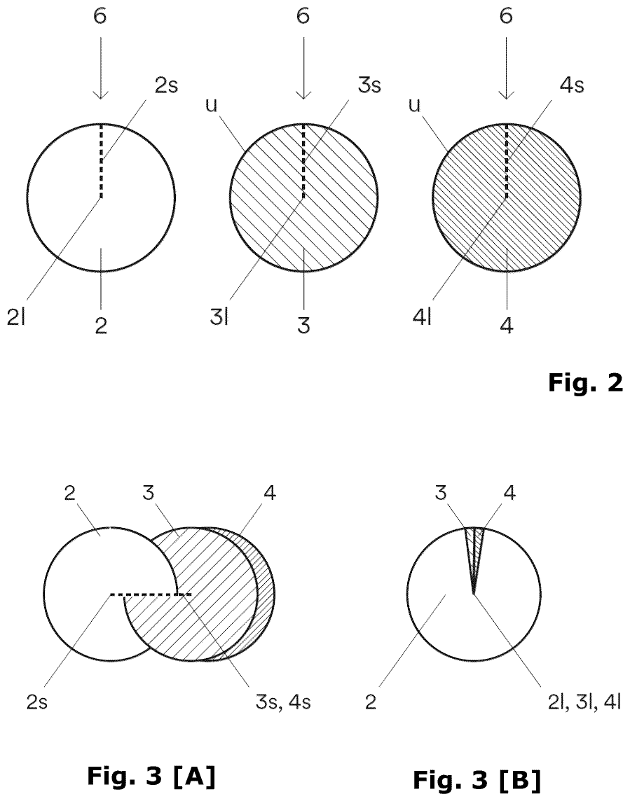

In FIG. 2, the three circular disks 2, 3, 4 are shown schematically. In this exemplary embodiment, they are circular and have the slot 2s, 3s, 4s, in each instance, which extends from the outer circumference U to the corresponding bearing point 2l,3l, 4l. The circular disks 2, 3, 4 are shown differently, in graphic terms, for this exemplary embodiment, so as to be better able to represent the corresponding functions. For the implementation of this method, it should be recommended that the respective circular disks 2, 3, 4 differ, since they assume different meanings, depending on their position, and the observer can thereby determine these meanings more easily.

In a first step, as shown in FIG. 2, preferably three identical circular disks, namely the first circular disk 2, the second circular disk 3, and the third circular disk 4 are to be produced. These circular disks 2, 3, 4 are flat by nature. In the case of the exemplary embodiment shown in FIG. 2, this is a round circular disk that is structured to be flat. Furthermore, it is flexible, in and of itself, and bendable, at least in part. It has, proceeding from its outer circumference to a center point of each of the circular disks 2, 3, 4, a slot 2s, 3s, 4s. The free ends 6 in the region of this slot 2s, 3s, 4s are such that they can be brought out of an almost common plane by means of a very slight expenditure of force. This means that in the indicating status, the respective end faces are arranged offset from one another in the region of the slot of the circular disks. This is made clear in the perspective of FIG. 1. The base of the slot, in each instance, i.e. the point at which the slot ends, is simultaneously a bearing point 2l, 3l, 4l for the corresponding circular disk 2, 3, 4.

For bringing the parts together, as shown in FIG. 3[A], the second and third circular disk 3, 4 are brought together centered and lying flat against one another, in such a manner that the respective slots 3s, 4s lie one on top of the other. The second and the third circular disk 3, 4 are now introduced into the slot 2s of the first circular disk 2, with the common slot 3s, 4s, preferably in a vertical position, to such an extent until the circular disks 2, 3, 4 are completely interlaced. In a further step, the second and third circular disk 3, 4 are laid into the plane of the first circular disk 2, so that the respective circular disks 2, 3, 4 are arranged parallel to one another. The respective bearing points 2l, 3l, 4l of the circular disks lie on a common imaginary axis formed by the interlacing, as it is identified in FIG. 1 with the reference symbol 5. The circular disks rotate about this imaginary axis 5 and are connected to one another helically on the basis of the interlacing, as can also be seen in a perspective view in FIG. 1 and in a top view in FIG. 3 [B].

Once the circular disks 2, 3, 4 have been interlaced with one another, they must be positioned in such a manner that the respective slots lie very close to one another, in the manner of a fan, as shown in FIG. 3 [B]. As a result, the third circular disk 4, viewed from above, is positioned in the first position, the first circular disk 2 in the second position, and the second circular disk 3 in the third position.

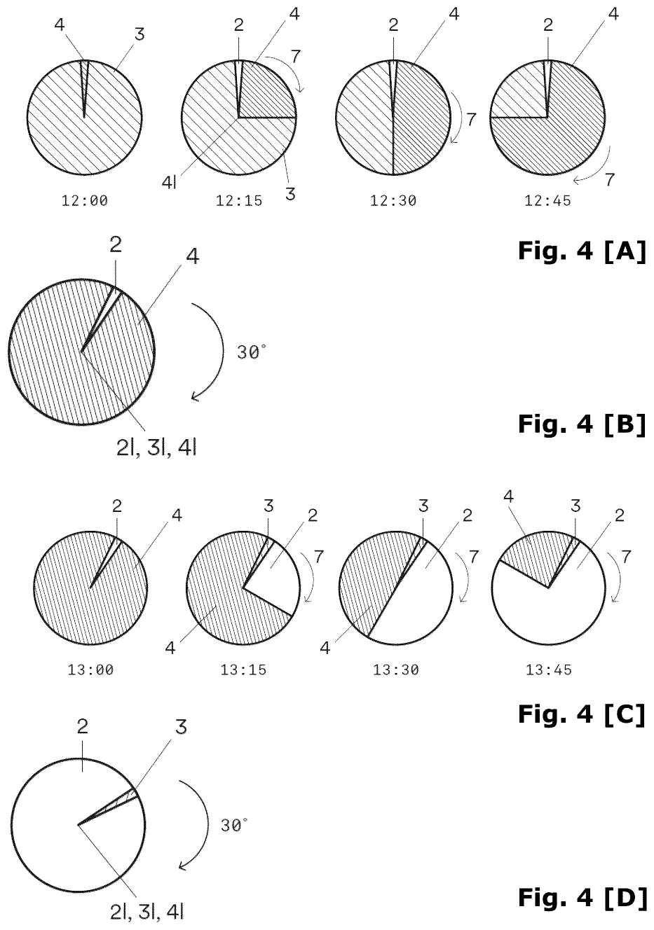

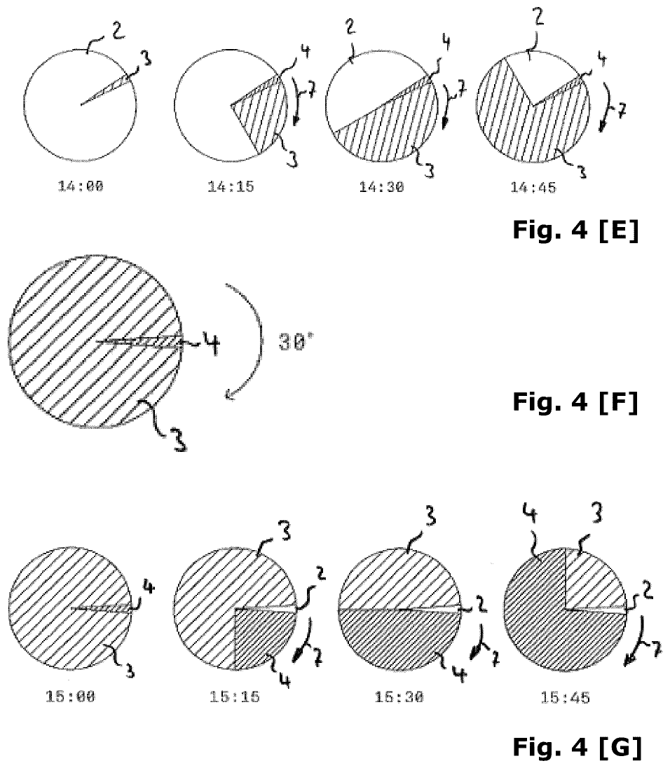

In the first hour, the third circular disk 4 is the indicator for the 60 minute cycle, the first indicator element 2 stands for the hour cycle, and the second circular disk 3 serves to represent the time ratio of the elapsed time to the remaining time within an hour. An example is shown in FIG. 4.

In FIG. 4[A], the time of day is shown between a time segment of 12:00 and 13:00, i.e. 1 p.m. The first circular disk 2 shows the hour, here 12 noon. It does not move within this time segment 12:00-13:00. The second circular disk 3 indicates the time still remaining until the next whole hour. This, too, remains in a fixed location within the time segment 12:00-13:00 and does not rotate. The second circular disk 3 is covered by the rotating third circular disk 4, which represents the minutes. This disk rotates by 360 degrees in 60 min, comparable to the minute hand of a conventional clock/watch, in a rotational arrow direction 7, about the bearing point 4l of the third circular disk 4. As a result, the third circular disk 4 covers the second circular disk 3, the farther the hour has advanced.

With the complete coverage of the second circular disk 3, all three circular disks move clockwise by 30 degrees (FIG. 4[B]). The first circular disk 2 is thereby moved, with its slot, to 1:00 or 13:00, respectively. The second circular disk and the third circular disk 3, 4 now move out of this slot, in such a manner that the second circular disk 3 moves to the 1:00 o'clock position with its slot and thus indicates the whole hour.

This step is shown in FIG. 4 [C] with the indication 13:15. The first circular disk 2 now becomes the minute indicator instead of the hour indicator, and shows the elapsed minutes, proceeding from the whole hour, proceeding from the position 1:00 or 13:00, respectively. In this regard, the first circular disk 2 covers the third circular disk 4 as the time of rotation increases. The movement of the first circular disk 2 takes place in one hour, by 360 degrees in the rotational arrow direction 7. The other circular disks 3, 4 do not move during the hour cycle, in this time window from 13:00-14:00.

When the third circular disk 4 has been covered completely, all three circular disks 2, 3, 4 move clockwise by 30 degrees (FIG. 4 [D]). As the result of this step, the second circular disk 3 is moved from the position 1:00 to 2:00. In FIG. 4 [E], this position is indicated as 14:00.

In a further step, the second and the third circular disk 3, 4 now move out of the slot, in such a manner that the third circular disk 4 assumes the position 2:00 or 14:00, respectively, and thus takes on the display of the hour. Previously, the third circular disk 4 showed the time still remaining until the whole hour. Now it has gone over to indicating the hour and remains fixed in place for the next 60 min. Furthermore, the second circular disk 3 is moved out of the slot. It now shows the actual minutes in the hour. It rotates by 360 degrees in the rotational arrow direction 7 in 60 min. In this regard, it increasingly covers the first, now fixed circular disk 2, which indicates the time remaining until the whole hour (FIG. 4 [E]). In FIG. 4 [E], the time of day between 14:00 and 15:00 or 2:00 and 3:00 is shown, respectively.

With the complete coverage of the first circular disk 2, all three circular disks 2, 3, 4 move clockwise by 30 degrees, as shown in FIG. 4 [F]. The first circular disk 2 is thereby moved to 3:00 with its slot. The third circular disk 4 now moves out of this slot, in such a manner that it covers the second circular disk 3.

In FIG. 4 [G], the time of day between 15:00 and 16:00 and 3:00 and 4:00, respectively, is shown. The first circular disk 2 now becomes the hour indicator and positions itself at 15:00 or 3:00, respectively. The third circular disk 4 now changes from being the hour indicator to being the minute indicator, and rotates by 360 degrees in the rotational arrow direction 7 in one hour. During this process, it covers the second circular disk 3.

As shown in FIG. 4 [G], the processes repeat every third hour.

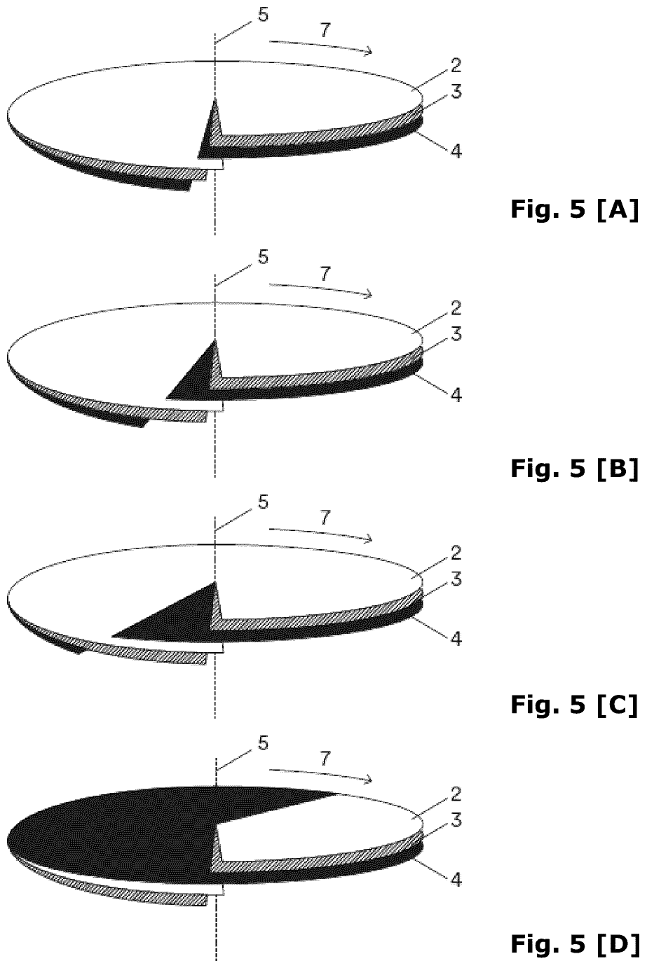

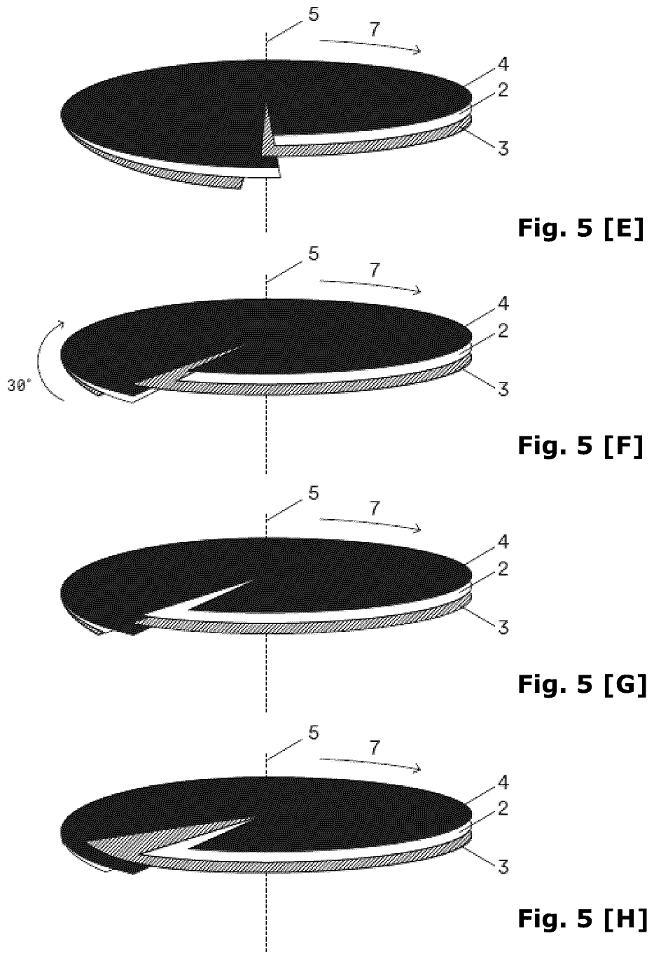

In FIG. 5 [A-H], different positions of the circular disks 3, 4, 5 are shown. In this regard, seen in a top view, the third circular disk 4 assumes the lowermost position, the second circular disk 3 assumes the middle position, and the first circular disk assumes the uppermost and thereby the first position. The figures show the rotational movement of the first circular disk 2, in such a manner that after a complete revolution of the first circular disk 2, the latter gets into the middle position (FIG. 5 [H]) and the third circular disk 4 gets into the uppermost position. From this representation, it becomes evident that the circular disk that is at the bottom always represents the minutes (in FIG. 5 [A-D]) and gets into the uppermost position by means of the rotational movement in the direction of the arrow 7. Once this position has been reached, as shown in FIG. 5 [E], a rotation of all the circular disks 2, 3, 4 by 30 degrees takes place in the direction of the arrow 7. Subsequently, the middle circular disk, here the first circular disk 2, is brought into the position for display of the hour (FIG. 5 [G]), wherein subsequently, the circular disk for the minutes (second circular disk 3, the lowermost circular disk) begins to indicate the minutes, starting from the hour position (FIG. 5 [H]).

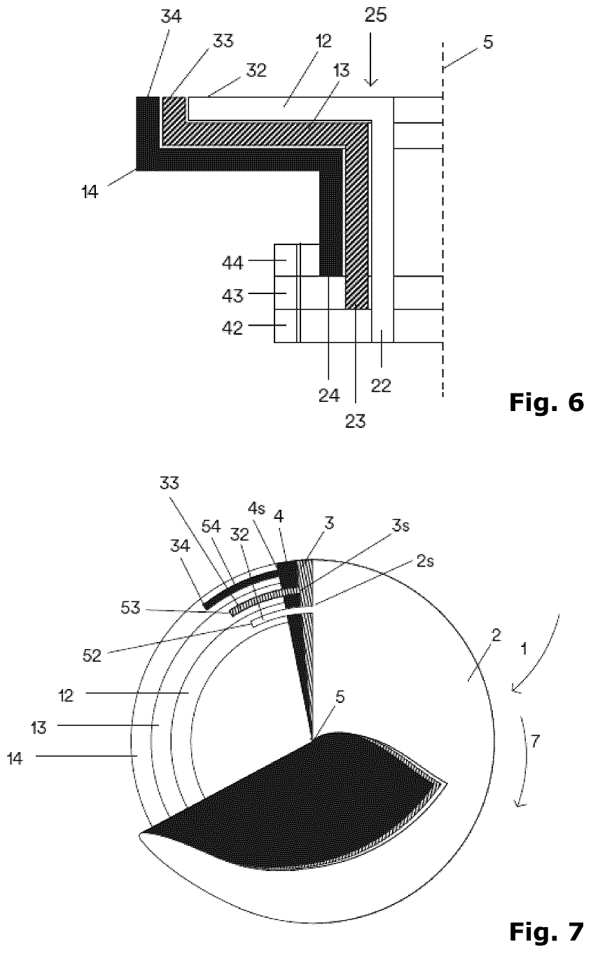

In FIGS. 6 and 7, a first exemplary embodiment of a display 1 is shown. FIG. 6 differs from FIG. 7 in that in FIG. 6, no circular disks 2, 3, 4 are shown, for simplification reasons with regard to the representation.

The display 1 has three drive disks 12, 13, 14. The third drive disk 14 has a circumferential surface at a distance from the bearing point (axis 5), which surface has one or more holding points 34 at its free end, in each instance. The second drive disk 13 is also structured with rotation symmetry and has a circumferential surface, at a distance from its bearing point, but the distance of this surface is less than the distance of the bearing point from the surface of the third drive disk. A part of the surface of the second drive disk 13 slides on the third drive disk 14. The second drive disk 13 also has holding points 33 at its free end. The first drive disk 12 has a circumferential surface at a distance from the bearing point, which surface also has one or more holding points 32. This surface, in contrast to the distance of the surface of the second drive disk from the bearing point, has an even lesser distance. This first drive disk 12 slides on a part of the surface of the second drive disk 13.

The free ends of the drive disks 12, 13, 14, in each instance, lie in a common plane, so that they can form the holding points 32, 33, 34 for the respective circular disks 2, 3, 4.

So that these drive disks 12, 13, 14 can also be driven by means of one or more actuating motors (not shown in the drawings), drive sleeves 22, 23, 24 are provided, which are arranged in one another, in each instance, and are connected to the respective drive disks 12, 13, 14. These drive sleeves 22, 23, 24 are arranged centered on or around the axis 5, so as to rotate, and in such a manner that in the region of the free end of the corresponding drive sleeve (arrow 25), namely on the side facing away from the drive disk, drive means 42, 43, 44 can be affixed directly or indirectly. These drive means 42, 43, 44, such as, for example, a drive wheel or a gear wheel (indicated in FIG. 6) or also a belt, can be coupled with a drive means, for example an actuating motor, in each instance. Each drive sleeve has a separate drive means.

The respective drive means are driven by way of a control unit. The control unit is preferably regulated by way of software, in such a manner that at first, calibration and thereby positioning of the circular disks takes place, and then, as a function of the time signal, setting of the time of day takes place. Alternatively, the time can also simply run, so that the observer recognizes how much time has elapsed or still remains (timer function).

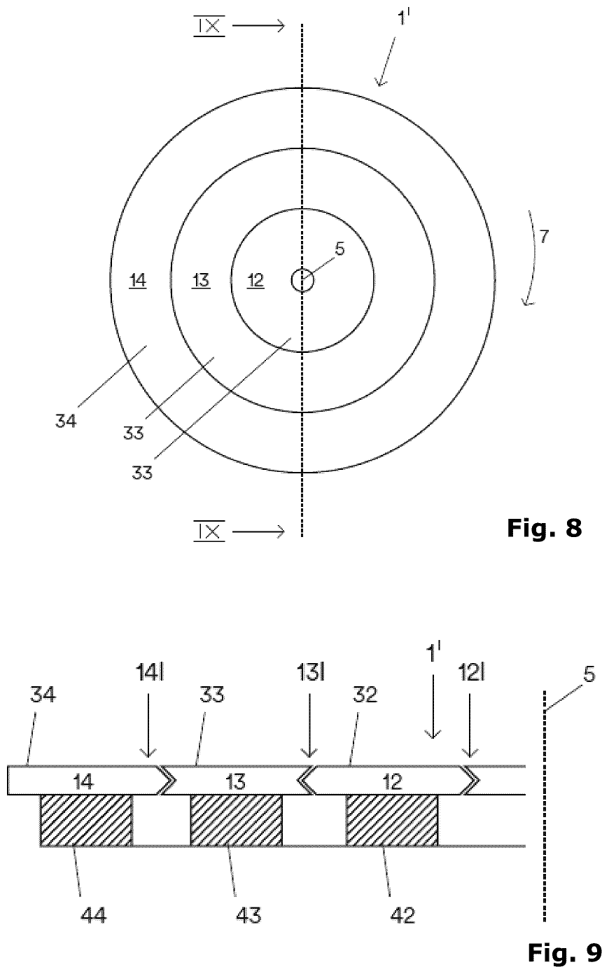

In FIGS. 8 and 9, a second exemplary embodiment of a display 1′ is shown.

The third drive disk 14 has a circumferential surface at a distance from the bearing point (axis 5), which surface has one or more holding points 34. The second drive disk 13 is also structured with rotation symmetry, and has a circumferential surface at a distance from its bearing point, the distance of which is, however, less than the distance of the bearing point from the surface of the third drive disk 14. Furthermore, holding points 33 are also provided. The second drive disk 13 is arranged in the same plane as the third drive disk 14. Furthermore, the third drive disk 14 offers a bearing possibility 14L for the second drive disk 13 on its inner side. This bearing possibility 14L can be, for example, a tongue/groove connection, wherein the tongue can slide in the groove. Since the inner side of the second drive disk 13 is also mounted in the outer side of the first drive disk 12, and a bearing possibility 13L is also provided, so that gliding is possible, the second drive disk 13 can slide in the first drive disk 12 and relative to the third drive disk 14. The first drive disk 12 has a circumferential surface at a distance from the bearing point, which surface also has one or more holding points 32. This surface, in contrast to the distance of the surface of the second drive disk 13, has an even lesser distance from the bearing point. All three drive disks 12, 13, 14 can rotate freely around their bearing point and thereby also about the axis, since the first drive disk 12 is also provided both with a first bearing possibility 13L and with a second bearing possibility 12L.

The respective drive disks are driven, in each instance, by means of drive elements 42, 43, 44, as shown in FIG. 9.

In order to guarantee a very compact and simple construction, it is proposed to use what are called torque motors as drive elements 42, 43, 44. These have different diameters. They are arranged on the underside, the side that faces away from the drive disks 12, 13, 14. The respective torque motors are preferably set into one another, in such a manner that the outer, largest actuating motor drives the first, outermost drive disk. The actuating motor is also limited just to the mass of the corresponding drive disk, in such a manner that the further torque motor fits into the first torque motor and drives the second drive disk. The same thing holds true for the third torque motor, which drives the third drive disk.

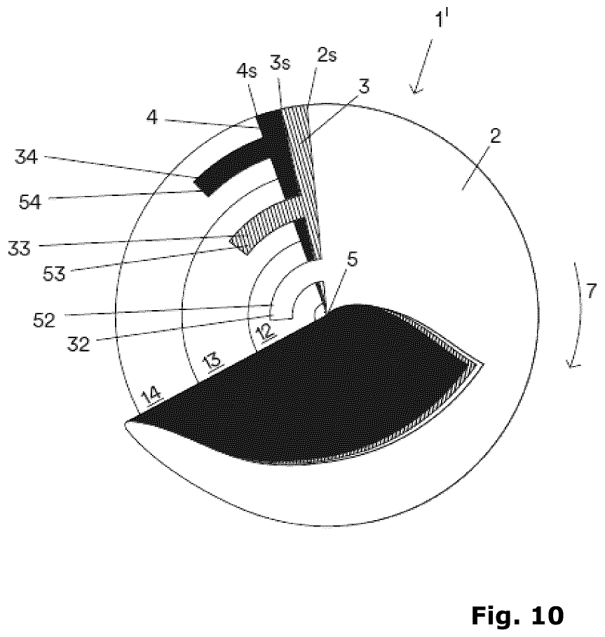

So that the circular disks 2, 3, 4 can be driven by the drive disks 12, 13, 14, and thereby these also run within one another in a helical manner and assume different positions in a top view, it is provided to attach the circular disks 2, 3, 4 on at least one holding point 32, 33, 34 of the corresponding drive disk 12, 13, 14. For coupling the corresponding circular disk 2, 3, 4 with the drive disk 12, 13, 14, a connection element 52, 53, 54 is provided, in each instance, which is arranged on the one side of the slot 2s, 3s, 4s of the corresponding circular disk 12, 13m 14. The connection elements 52, 53, 54 are are, as shown in FIG. 7 and FIG. 10, arranged at a radial distance from one another in a top view of the circular disks 2, 3, 4. The particular embodiment consists in that the connection element 52, 53, 54 of the corresponding circular disk 2, 3, 4 extends from the one side of the slot 2s, 3s, 4s, at which it is attached, beyond the slot, counter to the direction of rotation (counter to the direction of the arrow 7) and is attached, with the free end of the connection element 52, 53, 54, to the holding point 32, 33, 34 of the corresponding drive disk 12, 13, 14.

Since the circular disks 2, 3, 4 represent a circle, the connection element 52, 53, 54 is adapted to the shape of the circular disk 12, 13, 14. The connection element 52, 53, 54, in a top view, has has a partial segment of a circle, and the radius that corresponds to the radius from the corresponding holding point 32, 33, 34 to the axis 5.

The present display 1, 1′ consists of three very simply structured circular disks, which are mounted to rotate together and independently of one another on an axis. By means of forming a radial slot toward the bearing point, a helical structure can be achieved by means of interlacing. Without the individual circular disks actually being connected to one another in a non-releasable manner, the corresponding circular disk winds over the other by means of its own rotation. Thus, the respective circular disks change their function every hour, between indicating the hour, indicating the minute, and indicating the time remaining until the whole hour. For this reason, the device described and the method can be used as a clock/watch for indicating the actual time of day. The controller for the drive means, as described above, can preferably implement a receiver for reception of a time signal into a corresponding setting movement.

The method of interaction of the circular disks for indicating a unit of time, as described, is characterized by the display of the unit of time from changing partial segments of physical or virtual circular disks that rotate within one another, in the same direction, in a direction of rotation about a common axis, which together form a full circle, and the circular disks differ from one another optically. In this regard, the device departs from the usual representation that the 60 minutes of an hour are always represented by the start at “12 o'clock” and a rotation of 360 degrees, 6 degrees per minute. It is characteristic for the invention that the hour, starting from the full time of day (for example 8:00 or 15:00) always proceeds from this position of the segment of the circular disk that characterizes the hour.

### REFERENCE SYMBOL LIST

1 first exemplary embodiment of a display
1′ second exemplary embodiment of a display
2 first display element
3 second display element
4 third display element
5 virtual axis
6 outer circumference
7 rotational arrow
12 first drive disk
13 second drive disk
14 third drive disk
22 first drive sleeve
23 second drive sleeve
24 third drive sleeve
32 first holding point
33 second holding point
34 third holding point
42 first drive means
43 second drive means
44 third drive means
52 connection element
53 connection element
54 connection element
2l,3l,4l bearing point
12L, 13L, 14L bearing possibility
2s, 3s, 4s slot

1: A display of a device for representing a unit of time, wherein the display of the unit of time comprises partial segments, which change, of circular disks that rotate in the same direction within one another, in a direction of rotation about a common axis, which segments together form a full circle, and the circular disks differ from one another optically, wherein
a. three circular disks (2, 3, 4), each having a bearing point (2l, 3l, 4l), are provided,
b. the three circular disks (2, 3, 4) have essentially the same radius,
c. each of the three circular disks (2, 3, 4) has a slot (2s, 3s, 4s) extending from its outer circumference U to the bearing point (2l, 3l, 4l),
d. the three circular disks (2, 3, 4) are helically inserted into one another by way of the respective slots (2s, 3s, 4s) and come to lie flat on top of one another and, independently of one another, can be rotated by way of the common axis (5), in such a manner that these are interlaced with one another in a single helical stretch,
wherein the three circular disks (2, 3, 4) can be individually driven and controlled at least indirectly, in each instance.

2: The display according to claim 1, wherein
a. three drive disks (12, 13, 14) are provided,
b. each drive disk (12, 13, 14) rotates about the axis (5),
c. each drive disk (12, 13, 14) has at least one holding point (32, 33, 34),
d. drive disk (12, 13, 14) and holding points (32, 33, 34) are arranged in a plane,
e. each drive disk (12, 13, 14) can be driven by way of a drive element (42, 43, 44), wherein the drive element (42, 43, 44) can be controlled,
f. wherein each circular disk (2, 3, 4) is coupled with a different drive disk (12, 13, 14),
g. the coupling of the circular disk (2, 3, 4) with the drive disk (12, 13, 14) is provided by way of a connection element (52, 53, 54), which is arranged on the one side of the slot (2s, 3s, 4s), and
h. the connection elements (52, 53, 54), in a top view of the circular disks (2, 3, 4), are arranged at a radial distance from one another.

3: The display according to claim 2, wherein the connection element (52, 53, 54) of the corresponding circular disk (2, 3, 4) extends from the one side of the slot (2s, 3s, 4s) on which it is articulated, beyond the slot (2s, 3s, 4s), counter to the direction of rotation (arrow 7) and is attached, with its free end, to the holding point of the corresponding drive disk (12, 13, 14).

4: The display according to claim 3, wherein the connection element (52, 53, 54), in a top view, has a partial segment of a circle, and has the radius that corresponds to the radius of the corresponding holding point (32, 33, 34) from the axis.

5: The display according to claim 2, wherein the drive disks (12, 13, 14) can rotate clockwise.

6: The display according to claim 2, wherein the drive disks (12, 13, 14) are connected to drive sleeves (22, 23, 24), and the drive sleeves (22, 23, 24) are guided in one another in such a manner that they are arranged with rotation symmetry relative to the axis (5), and each drive sleeve (22, 23, 24) is coupled, at least indirectly, to a drive means (42, 43, 44).

7: The display according to claim 2, wherein the drive disks (12, 13, 14) are arranged in a plane and are coupled to one another so as to rotate about the axis, by way of guide elements.

8: The display according to claim 7, wherein the guide elements are tongue/groove connections, wherein the tongue is arranged to slide in the groove.

9: The display according to claim 7, wherein each drive disk (12, 13, 14) can be driven directly, using a drive means (42, 43, 44).

10: The display according to claim 9, wherein the drive means (42, 43, 44) are torque motors and wherein these have different diameters, so that they can be inserted into one another.

11-12. (canceled)
